(19) United States
(12) Patent Application Publication
(10) Pub. No.: US 2016/0015597 A1
(43) Pub. Date: Jan. 21, 2016

(54) Portable Infrared Sauna

(71) Applicant: Brian Richards, Columbia, MO (US)

(72) Inventor: Brian Richards, Columbia, MO (US)

(73) Assignee: SaunaSpace LLC, Columbia, MO (US)

(21) Appl. No.: 14/800,511

(22) Filed: Jul. 15, 2015

Related U.S. Application Data
(60) Provisional application No. 62/026,647, filed on Jul. 20, 2014.

(51) Int. Cl. A61H 33/06; H05B 3/00; H05B 1/02

(52) U.S. Cl. CPC A61H 33/066; H05B 1/0275; A61H 33/063; H05B 3/008; A61H 2033/061; A61H 2201/0207; A61H 2201/0221; A61H 2201/0157; A61H 2201/0161

(57) ABSTRACT

Disclosed in this document are devices and methods for creating temporary enclosures made substantially of wood or cellulose based materials that are unadulterated or not processed with foreign chemicals, wherein the enclosure is capable of supporting a bulb assembly to form a temporary sauna. One embodiment of the temporary enclosure is a near infrared sauna system that supports a near infrared heat source and maintains adequate temperature. The infrared sauna system exposes a person sitting inside the enclosure to the comfort and benefits of a near infrared sauna. In this document, innovative elements combine to create a temporary building structure that overcomes the need for nails, screws and other external tools previously necessary when using unadulterated materials, such as poplar wood and bamboo.

### FIELD

This document relates to devices for constructing portable or temporary structures and methods of use thereof. More specifically, this document relates to a portable infrared sauna.

### CROSS REFERENCE TO RELATED APPLICATION

This application claims priority to U.S. Provisional Application Ser. No. 62/026,647, filed on Jul. 20, 2014, which is incorporated herein by reference in its entirety.

### BACKGROUND

Traditional saunas lack convenience, and require significant upfront investment. Traditional saunas are usually shared among communities in settings like health clubs. The health and comfort benefits of traditional saunas are enjoyed in private settings only by those who can afford the upfront cost, the utilities and the maintenance. A need exists to make a new type of sauna that can be made from inexpensive materials and used at home or other locations of choice. Ideally, the sauna would be portable so that the locations could vary. Instead of heating up a large room, the new type of sauna would be energy efficient and target the heat and energy on the user.

The inexpensive sauna would have additional utility if it were also deployable and collapsible without any tools or the work of more than one person. The collapsed version could be transported easily, so that the sauna could be deployed at a location of choice.

Such a sauna would be particularly appealing to users if it delivered the health benefits of infrared light while exposing the user to minimal undesired elements and compounds. Infrared light is beneficial for many reasons, including but not limited to improved circulation, relief of internal congestion, release of toxins and promotion of a healthy immune system. While not only helping the user, the sauna would also be environmentally friendly and preferably made from renewable resources.

The need to create structures comprised of frames and covering enclosures that are portable and collapsible without any tools also exists beyond saunas. The portable and collapsible enclosure must be capable of being transported easily but it also requires the rigidity to support a bulb assembly to supply energy into the sauna.

### SUMMARY

Disclosed in this document are devices and methods for creating temporary enclosures made substantially of wood or cellulose based materials that are unadulterated or not processed with foreign chemicals and thereby limiting the release of volatile organic compounds, wherein the enclosure is capable of supporting a bulb assembly to form a temporary sauna using infrared light, and more preferably, near infrared light. One embodiment of the temporary enclosure is a near infrared sauna system that supports a near infrared heat source and maintains adequate temperature. The near infrared sauna system exposes a person sitting inside the enclosure to the comfort and benefits of an infrared sauna. In this document, innovative elements combine to create a temporary building structure that overcomes the need for nails, screws and other external tools previously necessary when using unadulterated materials, such as poplar wood and bamboo. The sauna system not only provides therapeutic benefits of near infrared energy, but it is also designed to be portable and it can be disassembled easily, all while providing a safe environment for the user to receive the benefits of near infrared therapy. As used herein, unadulterated is intended to mean that the materials are not processed with any added chemicals (untreated wood).

The sauna system disclosed is a specific type of sauna system that harnesses infrared energy and more specifically, near infrared energy. In this description, near infrared energy and near infrared light and infrared heat are all used to describe the infrared energy harnessed by the disclosed sauna system. And, while the disclosure focuses on this specific sauna system, some of the innovative building elements used in the sauna system are believed to be independently novel in broader applications, such as temporary building structures that do not require the use of any tools.

A heat source assembly delivers the near infrared light. Innovative guards protect the user from direct contact with the light source and protect the fragile bulbs that act as the near infrared light source. The guards allow sufficient infrared energy to flow to the user.

The wooden enclosure is comprised of support rods and pocket couplings that connect the support rods in a desired framework, and the framework supports a near infrared energy source and a cover that encloses the framework and the near infrared energy source and provides sealing effects to the enclosure. Some energy will escape, but the cover seals the enclosure adequately so that the air temperature inside of the enclosure facilitates inducing a hyperthermic state in the user or users who are inside the enclosure. A hyperthermic state is achieved by maintaining an ambient air temperature that is above body temperature and below 130 degrees Fahrenheit while focusing an infrared light on the body to heat the body of the user internally.

The pocket couplings that connect the support rods consist of a plurality of sockets that receive and hold the support rods in a desired configuration relative to the other support rods. One significant benefit of these particular pocket couplings is that they connect to the support rods without any tools. The structure can be assembled and disassembled without the use of screw drivers, wrenches, or any other type of external tool and can be assembled or disassembled by one person. The support rods require a push against the pocket coupling so that the support rod fits into the socket of the pocket coupling. The support rods require a pull against the pocket coupling to get the support rod out of the pocket coupling for collapsing the framework. The push-pull capability makes these pocket couplings appealing for temporary applications.

The pocket couplings connect a plurality of support rods in configurations that deliver the desired structure. This document discloses two way pocket couplings that are straight, two-way pocket couplings that are elbows, three-way pocket couplings that are tees, three-way pocket couplings that are corners, four-way pocket couplings, five-way pocket couplings and six-way pocket couplings.

One embodiment of the pocket coupling is a fabric that is reinforced by semi-rigid inserts to make coupling pieces that are flexible sockets. The inserts are of opposing and identical shapes that are surrounded by fabric in substantially the same shape. The fabric does not surround the inserts completely, to leave a spot to receive a support rod, called a socket. The void between the two inserts is the socket, and the inserts can bend to surround a support rod, which allows it to apply pressure to grip and hold a range of diameters. Because overall weight of the structure is important, support rods that are greater than three inches in diameter are not desirable.

The sockets in the fabric pocket couplings are specifically sized so that they can receive a range of support rod diameters. This allows it to receive and hold snugly different types of support rods, such as those that would be experienced if using natural, unadulterated bamboo as the support rods. When the material used is bamboo, this range must be and is consistent with the range of diameters of natural bamboo. In this embodiment used for bamboo rods, the insert in the fabric pocket coupling may be plastic, and is the only plastic used in the bamboo rod embodiment.

The sockets must be deep enough to hold a range of support diameters but should not be so long as to become impractical. A minimum depth of the socket is about two inches, although as little as one inch will be suitable when short support rods are used of a small diameter. Short support rods would be less than three feet and typical diameter would be one inch or less.

Another preferred embodiment of the pocket couplings is disclosed herein, wherein three dimensional shapes with sockets in the shapes comprise the pocket couplings. The shapes are preferably cubes or rectangular prisms, but can also be pyramids, cones, polygonal three-dimensional shapes, spheres and any other shape.

The three-dimensional shapes are made from a rigid material, preferably an unadulterated material such as wood. The tolerance of the sockets in the three-dimensional shapes is tighter than in the fabric pocket couplings. Thus, the shape pocket couplings apply best when support rods of substantially consistent diameter are used.

The socket pocket couplings combined with the support rods will form a frame that may be assembled without the use of any tools. A user simply needs to push the support rods into the pocket couplings during assembly and the user simply pulls the support rods out of the pocket couplings during disassembly.

The support rods are ideally bamboo or poplar wood or some other wood product or product that is substantially cellulose to minimize emission of volatile organic compounds that can be released by polymers. It is an object of this invention to minimize the use of adulterated materials. The ideal wood product, such as bamboo or poplar, will have a strength to weight ratio that allows it to support a near infrared energy source and a cover in addition to the frame itself, but also allows it to be less than thirty-five pounds so that it is easily portable. An ideal material is poplar wood for the support rods and pocket couplings. For larger, two-person sauna systems, the entire system will be eighty or less pounds.

Together, the pocket couplings and the support rods form the framework of the enclosure and support the cover and near infrared energy source.

The infrared heat source comprises a plurality of near infrared bulbs arranged in a housing containing wiring that generally wires the plurality of near infrared bulbs together. In one embodiment, the housing is a substantially box shaped wooden enclosure made from wood materials that contain no added chemicals. The bulbs are directed away from a wall on the box and the bulbs are covered with a protective guard to prevent direct contact between the user and the bulbs. The assembly is attached to the two vertical support bars that extend from the side of the footprint with the smaller parallel side of the trapezoid. The box can also be a panel. Only a minimal amount of plastics are used in the electrical wiring in order to meet wiring standards. Thus, the infrared heat source assembly is comprised primarily of materials that do not emit volatile organic compounds.

The near infrared energy source provides comfort and therapeutic benefits. Due to the simplicity of the connections and the lightweight and associated portability of the framework and cover, the entire near infrared sauna can be transported to locations of choice, such as the home and even different locations within the home. The cover will effectively seal heat and the guards enclosing the infrared bulbs protect users from direct contact with hot bulbs.

Although this disclosure generally refers to the footprint of the enclosure as trapezoidal, it is intended to be within the scope and claims of this disclosure to cover shapes that are not exact trapezoids. The trapezoidal footprint of the enclosure includes enclosures having support rods on a small sidewall used to support the near infrared assembly and use of a slightly larger sidewall on another side to fulfill the function of allowing for an entryway. The relatively smaller sidewall used to support the infrared assembly prevents wasted space near the infrared bulb space because this is an area that is often unusable because a user should not be within ten inches of the infrared bulb space.

The ideal distance is between eighteen and thirty inches from the infrared source to the user's torso. The lack of wasted space in this design makes the entire enclosure lighter and portable. The substantially isosceles trapezoid allows for easier assembly and less materials and pieces than if the frame was square.

### BRIEF DESCRIPTION OF DRAWINGS

FIG. 1 is a canvas 3-way pocket coupling.

FIG. 2A is a front view of the sauna system.

FIG. 2B is a side view of the sauna system.

FIG. 2C is a top view of the sauna system.

FIG. 3A shows a 1-way and a 2-way canvas pocket couplings.

FIG. 3B shows a 3-way and a 4-way canvas pocket couplings.

FIG. 4A shows a support rod before it is inserted into the canvas pocket coupling.

4B shows a support rod connecting with canvas pocket couplings.

FIG. 5A shows a 1-way wood pocket coupling viewed from each side as well as the top and also shows a 2-way wood pocket coupling viewed from each side as well as the top.

FIG. 5B shows opposing views 3-way wood pocket coupling (Ver. A and Ver. B) from two sides and from the top as well as a 4-way wood pocket coupling viewed from one side and from the top.

FIG. 6 is the infrared bulb heat source assembly.

FIG. 7A is a section view facing the entrance of the covered sauna system.

FIG. 7B is a section view of the side of the covered sauna system.

FIG. 7C is a top view of the covered sauna system.

FIG. 8 is the mounting bracket with a view a user would see when looking in a direction parallel to the floor and with a view a user would see when looking in a direction perpendicular to the floor.

FIG. 9 is the bulb guard assembly and shows a top view which would be seen by a user when looking in a direction perpendicular to the floor and a side view would be seen by a user when looking in a direction parallel to the floor.

### DETAILED DESCRIPTION OF DRAWINGS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the claims and appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the disclosed invention can include a variety of combinations and/or integrations of the embodiments described herein.

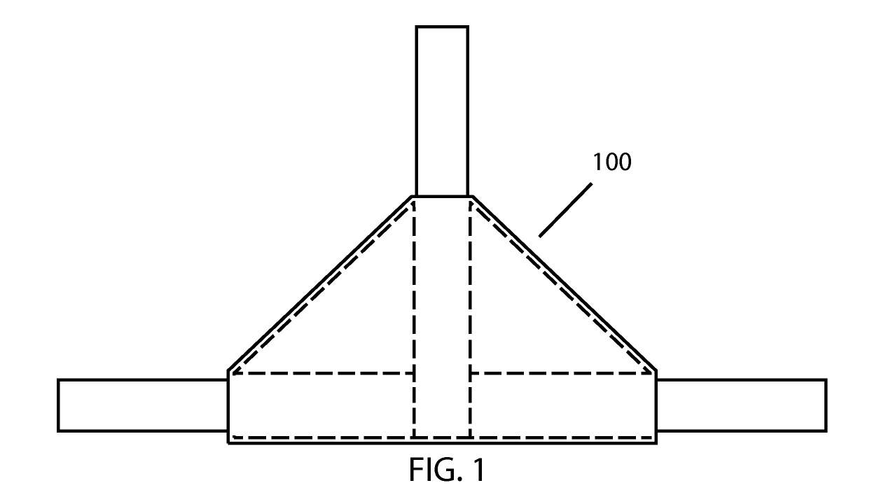

Disclosed in this document are devices and methods for creating temporary enclosures made substantially of wood, bamboo or natural cellulose based materials that are coupled together without the use of screws or nails, or any tools such as a hammer. Instead, support rods fit into a 3-way pocket coupling 100 as shown in FIG. 1 with a push-pull assembly that requires only one user's two hands for assembly and disassembly. The preferred embodiment of a temporary enclosure is an infrared sauna system that supports an infrared heat source and seals heat inside the enclosure and has a number of innovative elements that can be included in various embodiments, or independently inventive. The infrared sauna system exposes a person sitting inside the enclosure to the comfort and benefits of an infrared sauna and the structure captures enough heat so that a more consistent body temperature can be maintained throughout the body. The air temperature inside of the enclosure facilitates inducing a hyperthermic state in the user or users who are inside the enclosure. A hyperthermic state is achieved by maintaining an ambient air temperature that is above body temperature and below 130 degrees Fahrenheit while focusing a near infrared light on the body to heat the body of the user internally. Additionally, the enclosure does not create a complete seal. Instead, the cover breathes to let some outside air in.

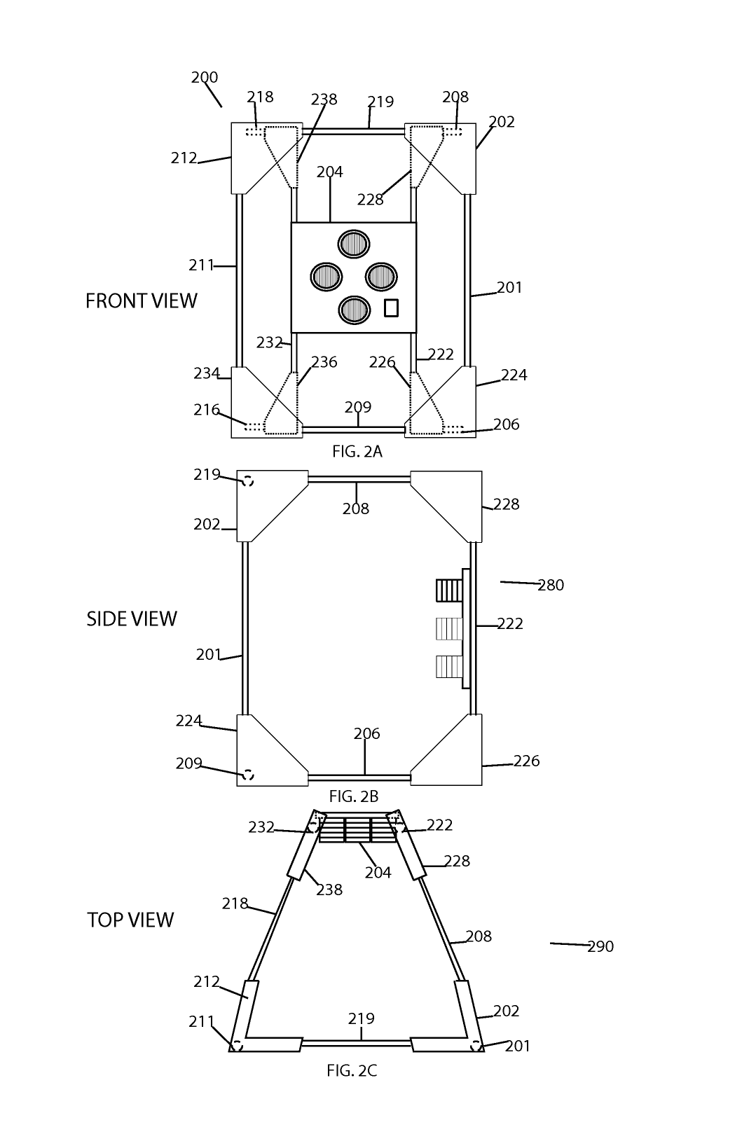

The preferred embodiment of the infrared sauna system is a near infrared sauna system comprising a number of inter-compatible and inventive elements. Referring to the uncovered frame in FIG. 2, the frame is comprised of support rods, such as 201 and pocket couplings, such as 202, that connect the support rods in a temporary framework, and the framework supports an infrared energy source 204 and a cover (not shown in FIG. 2 drawings—see FIG. 7 drawings) that encloses the framework and the infrared energy source and provides sealing effects to the enclosure. Some energy and air will escape the enclosure which is desirable, but the cover seals the enclosure adequately so that the air temperature inside the enclosure is adequate for sauna therapy or hyperthermic therapy for the user or users who are sitting inside the enclosure. The material used for the cover will impact the amount of energy that escapes the enclosure. The number of layers impacts the insulation factor, making the sauna adaptable to various environments by use of different cover materials and weights.

The pocket couplings, such as pocket coupling 100 in FIG. 1 that connect the support rods, such as shown with pocket coupling 202, consist of a plurality of sockets that receive and hold the support rods in a desired configuration relative to the other support rods which are shown in FIG. 2. These pocket couplings can be used in other settings because the pocket couplings are applicable to a wide range of temporary structures. One significant benefit of the pocket couplings is that they connect to the support rods without requiring the use of tools. The support rods require a push against the pocket coupling so that a support rod fits into a socket of the pocket coupling. The support rods require a pull against the pocket coupling to get the support rod out of the pocket coupling for collapsing the framework. The push-pull capability makes these pocket couplings appealing for temporary applications.

The pocket couplings, such as 202 in FIG. 2 connect a plurality of support rods. There are two-way pocket couplings that are straight, two-way pocket couplings that are elbows, three-way pocket couplings that are tees, three-way pocket couplings that are corners, four-way pocket couplings that are flat or corners, five-way pocket couplings and six-way pocket couplings.

One embodiment of the pocket coupling is a fabric shell that is reinforced by semi-rigid inserts. The shell consists of two substantially identical and opposing pieces of fabric. The inserts are of opposing and identical shapes that are surrounded by fabric in substantially the same shape. Ideally, the fabric and inserts are stitched together to enclose the couplings and to create sockets, however, the fabric and inserts can be coupled together in other ways, such as stapling or fusing. The sockets are designed to receive support rods. The inserts can bend or flex to surround a support rod, and to apply pressure to grip and hold a range of diameters. The elasticity of the semi-rigid inserts applies pressure to grip support rods that are put into the socket. Because overall weight of the structure is important, support rods that are greater than three inches in diameter are not desirable. The semi-rigid inserts are made from sheets of plastic.

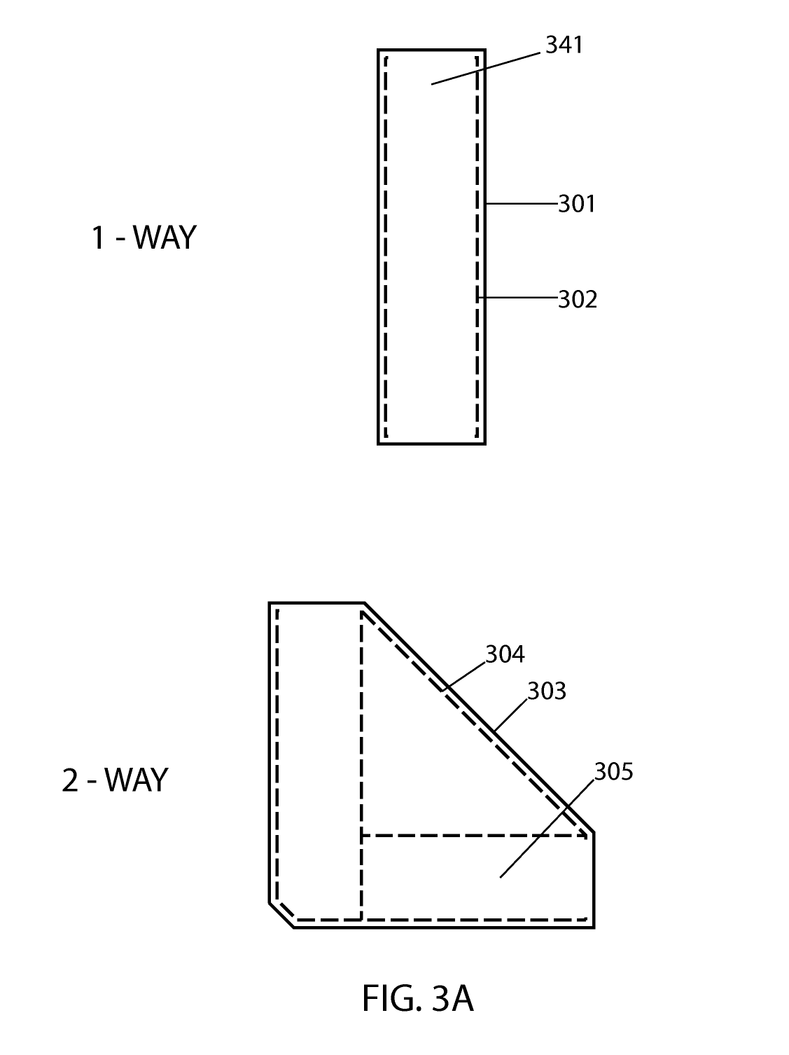

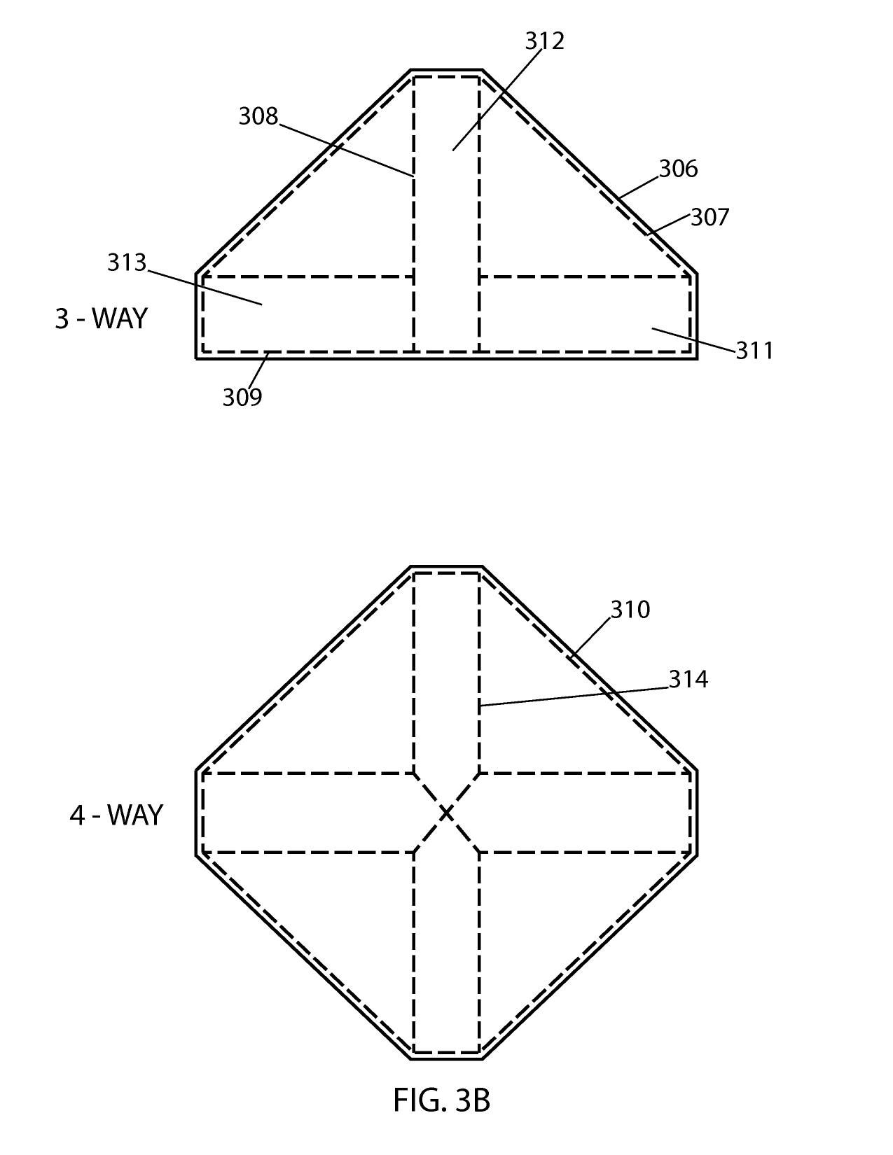

In the one-way pocket coupling in FIG. 3A, the fabric 301 surrounds two opposing inserts that provide rigidity. In the preferred embodiment, the inserts are about the same size as the fabric 301 and the stitching 302 goes through the inserts. When a support rod fits into the socket 341, the inserts provide structure and strength. The two-way pocket coupling shows an elbow pocket coupling where the fabric 303 surrounds a triangular insert. In the preferred embodiment, the stitching 304 goes through the plastic inserts that are substantially the same size as the fabric 303. However, in other embodiments, the plastic could be sized slightly smaller, or a plurality of opposing inserts could be used. In the preferred embodiment, the stitching outlines the sockets that receive support rods. The stitching does not extend over the sockets 305. The three-way pocket coupling in FIG. 3B shows a three way pocket coupling. The pocket coupling could receive three support rods in three separate sockets 311, 312, and 313 in three different directions. The support rods could all be in the same plane, but in the preferred sauna enclosure embodiment the pocket coupling can be folded so that it creates a corner. In the corner configuration, two of the sockets 311 and 313 would be folded so that the two sockets are substantially perpendicular. Fabric 306 surrounds two opposing triangular inserts that provide structure. Stitching 308 and 309 outlines the sockets and stitching 307 encloses the inserts and pocket coupling. This support rod design can be extended to additional fittings, such as a 4-way fitting shown in FIG. 3B, with stitching 310 holding two opposing faces together and stitching 314 on the socket pockets.

The sockets in the fabric pocket couplings are sized so that they can receive a range of support rod diameters. This allows the fabric pocket couplings to receive and hold snugly different types of support rods, such as those that are experienced when using unadulterated bamboo as the support rods or other natural materials that may be tapered. In a preferred embodiment, this range is consistent with the range of diameters of natural bamboo.

The sockets must be deep enough to hold a range of support diameters but should not be so long as to become impractical. A minimum depth of the sockets is about two inches, although as little as one inch will be suitable when short support rods are used of a small diameter. Short support rods would be less than three feet and small diameter would be one inch or less. The sockets depth becomes impractical when it is so long that it adds unneeded weight to the entire structure. The socket depth also becomes impractical when the support rods need to be bent too much to put the last support rod into a socket. More specifically, these depths become impractical when the depths exceed eight inches.

The fabric can be a range of materials. Preferred materials are materials that are natural, unadulterated and do not provide any unwanted gases, namely volatile organic compounds, when heated or exposed to infrared light. These materials include canvas, bamboo slates, cane, hemp burlap, jute plant fibers or other woven natural fiber. The preferred embodiment is canvas.

Another type of the pocket couplings is disclosed herein, where three-dimensional shapes with sockets in the shapes comprise the pocket couplings. The shapes can be cubes or rectangular prisms, pyramids, cones, polygonal three-dimensional shapes, spheres and any other shape.

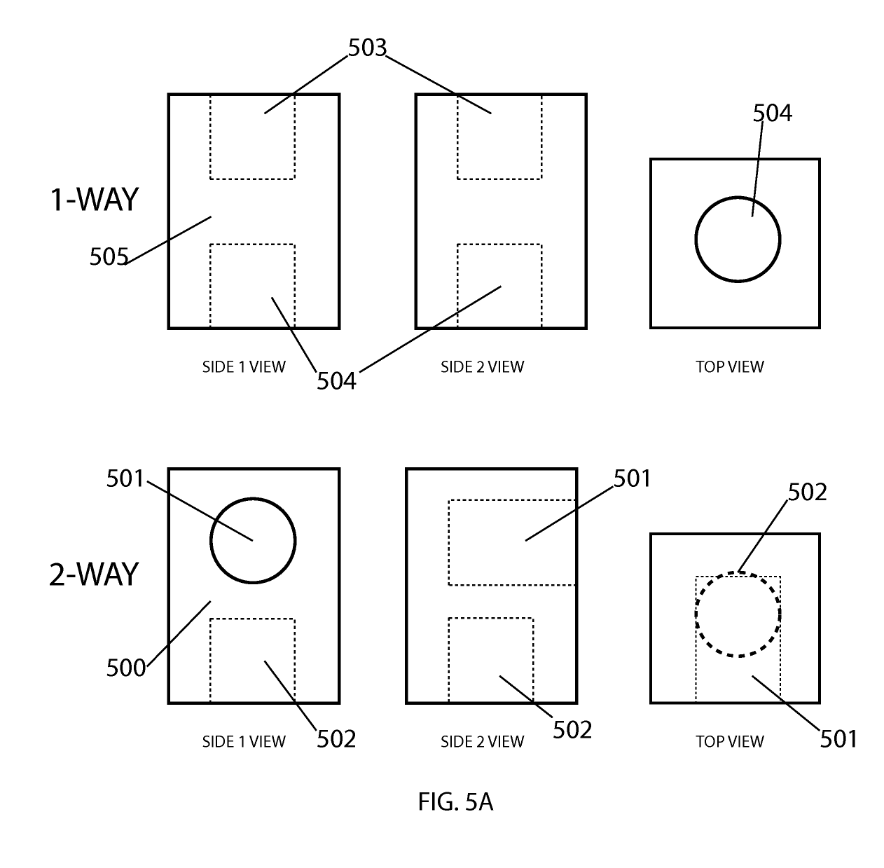

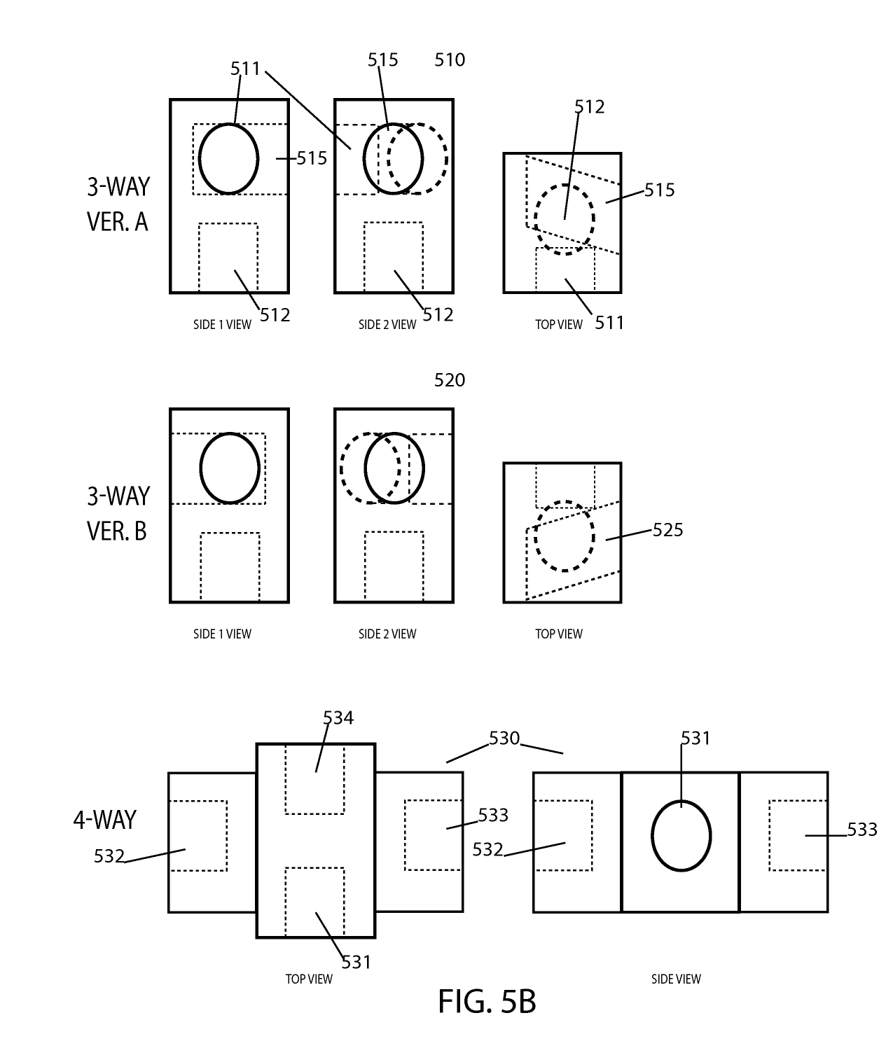

FIGS. 5A and 5B show the preferred embodiments of cubic or rectangular prisms which are the shapes that are pocket couplings. FIG. 5A shows a one-way (one-way refers to one direction but two sockets) pocket coupling 505 with sockets 503 and 504. FIG. 5A also shows a two-way or elbow 500 with two sockets 501 and 502 that are directed substantially perpendicular. The sockets will hold support rods which can thus be coupled together without the use of any tools. Only a push and a pull are required for assembly.

FIG. 5B shows two three-way pocket couplings 510 and 520 and one four-way pocket coupling 530. In the preferred embodiment, the three-way pocket couplings have opposite sockets 515 that are off of the ninety degree angles created by the other two sockets 511 and 512. The angle between socket 515 and socket 511 forms the angle of the trapezoidal footprint or ceiling. Three-way pocket coupling 520 forms the opposing pocket coupling to form the trapezoidal footprint or ceiling of the enclosure by making socket 525 of Ver. B a mirror image of the angle of the other socket 515 shown Ver. A. Four-way pocket coupling 530 has sockets 531, 532, 533, and 534 that can couple four support rods together.

The three-dimensional shapes are made from a rigid material, preferably a unadulterated material such as wood. The tolerance of the sockets in the three-dimensional shapes is tighter than in the fabric pocket couplings. Thus, the three-dimensional shape pocket couplings apply best when support rods of substantially consistent diameter are used.

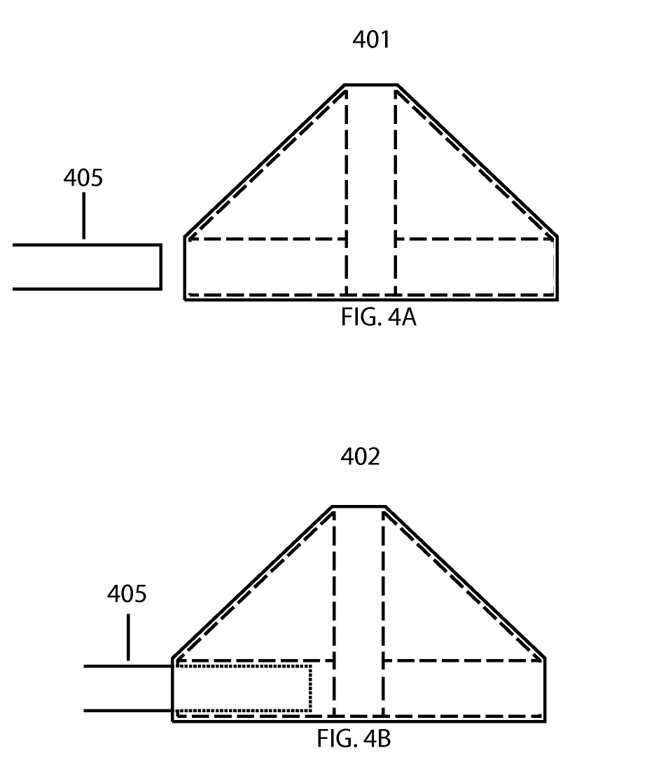

The pocket couplings combined with the support rods will form a frame that may be assembled without the use of any tools. A user simply needs to push the support rods into the pocket couplings during assembly and the user simply pulls the support rods out of the pocket couplings during disassembly. Referring to FIGS. 4A and 4B, a user can push a support rod 405 so that it fits inside the pocket coupling 402. Similarly, the user can pull the support rod 405 out of the pocket coupling 401. Similarly, a user can push and pull support rods into the cubic and rectangular prism pocket couplings without the use of any tools. The push-pull assembly does not require the use of any tools, and only requires the one user's two hands to assemble and disassemble.

Together, the pocket couplings and the support rods form the framework of the enclosure and support the cover and infrared energy source. The infrared sauna system can be assembled and disassembled easily by one person. When disassembled, the entire system can be put into a compacted form which consists of a dissembled sauna system in a carrying case. The ideal wood product, such as bamboo, will have a strength to weight ratio that allows it to support an infrared energy source and a cover in addition to the frame itself, but also allows it to be less than eighty pounds so that it is easily portable.

In the preferred embodiment, the sauna is made of substantially unadulterated materials and only the minimal amount of plastic is used to prevent the release of volatile organic compounds released from polymers, particularly when exposed to heat. Therefore, the frame is preferably made of wood, the cover is preferably made of canvas, and the heat source assembly is primarily comprised of a wood panel and steel guards, but does contain a minimal amount of plastics used to meet proper wiring standards as the plastic is needed as insulation, for example. Therefore, the heat source assembly is comprised of materials that minimize the emission of volatile organic compounds.

Referring to FIGS. 2A, 2B and 2C, which refers to a front view, a side view and a top view respectively making up the sauna framework 200, there are four vertical support rods 201, 211, 222 and 232 of substantially equal length. The four vertical support rods are arranged at the corner of a two dimensional shape that is substantially trapezoidal 290, and are coupled to a base that is substantially trapezoidal using pocket couplings. The support rods are coupled together using push-pull pocket couplings which can be the canvas pocket couplings shown in FIG. 3 or the cubic or rectangular prism shapes shown in FIG. 5.

The vertical support rods 201, 211, 222, and 232 must be long enough to accommodate a range of user preferences, but should generally be between three feet and ten feet. In the preferred embodiment, the vertical support rods are between four feet and seven feet as it strikes an optimum balance between weight of the system and volume inside the enclosure. The most preferable range is five to seven feet. Two of the vertical support rods, 201 and 211, fit into three way pocket couplings and are thereby coupled to additional horizontal support rods. The FIG. 2 drawings show four three-way pocket couplings, two on the top 202 and 212, and two on the bottom of the structure, 224 and 234. The two vertical support rods 201 and 211 are separated by enough space to allow for an entry way and are separated by horizontal support bars 209 and 219. The two vertical support rods 201 and 211 are also coupled to horizontal support rods 218, 208, and 219 at the top and support rods 209, 216, and 206 at the bottom. These support rods provide depth to the structure, and should be sized to balance portability with the range of distances that a user would like to sit from the infrared heat source, since the infrared source will be located on the rear face of the enclosure. Horizontal support rods 206, 216, 208 and 218 connect with two way elbows or pocket couplings 226, 236, 228, and 238 and the elbows connect to the rear vertical support rods 222 and 232. The pocket couplings can be the canvas type described in FIG. 3 or the cubic and rectangular prism shapes shown in FIG. 5.

The space between vertical support rods 201 and 211 is greater than the space between rear vertical support rods 222 and 232 because vertical support rods 201 and 211 will support the entryway. Rear vertical support rods 222 and 232 will support the infrared heat source assembly 204.

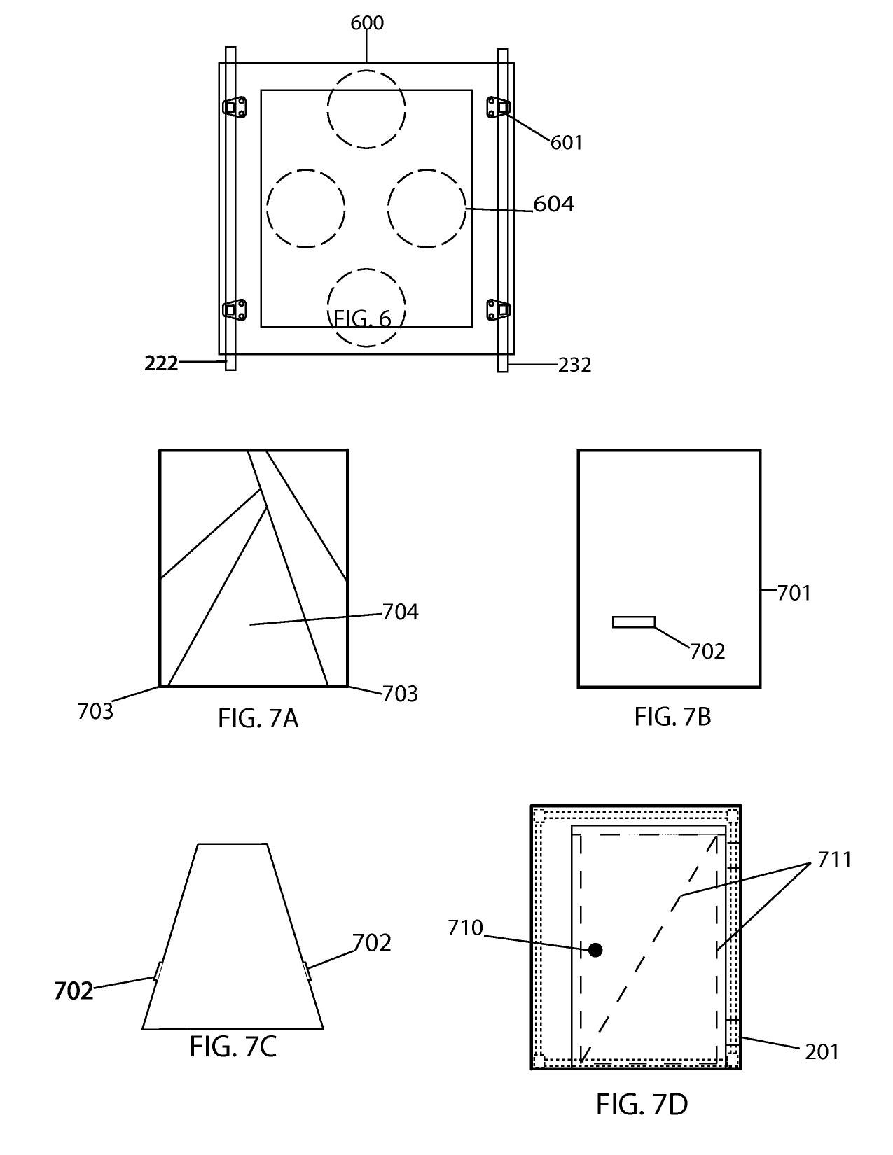

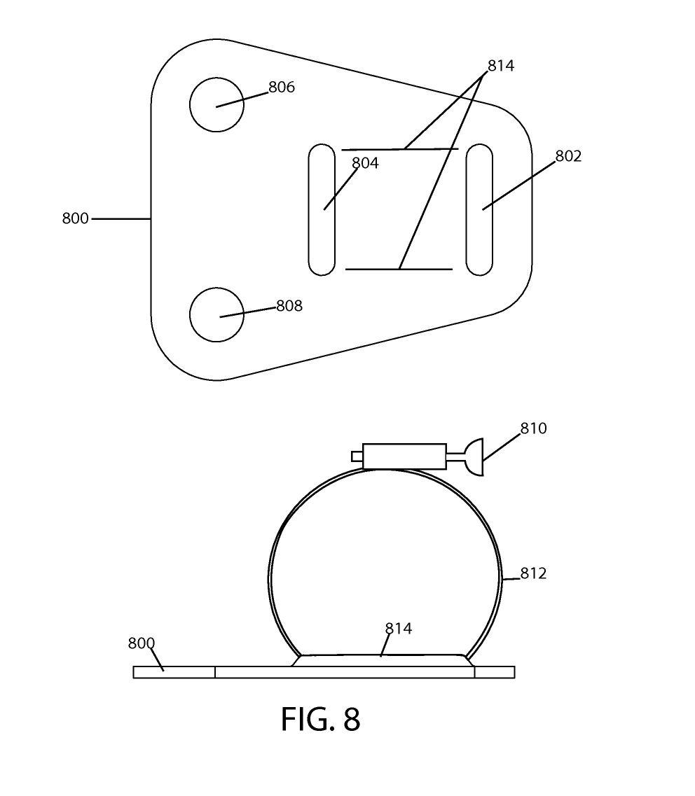

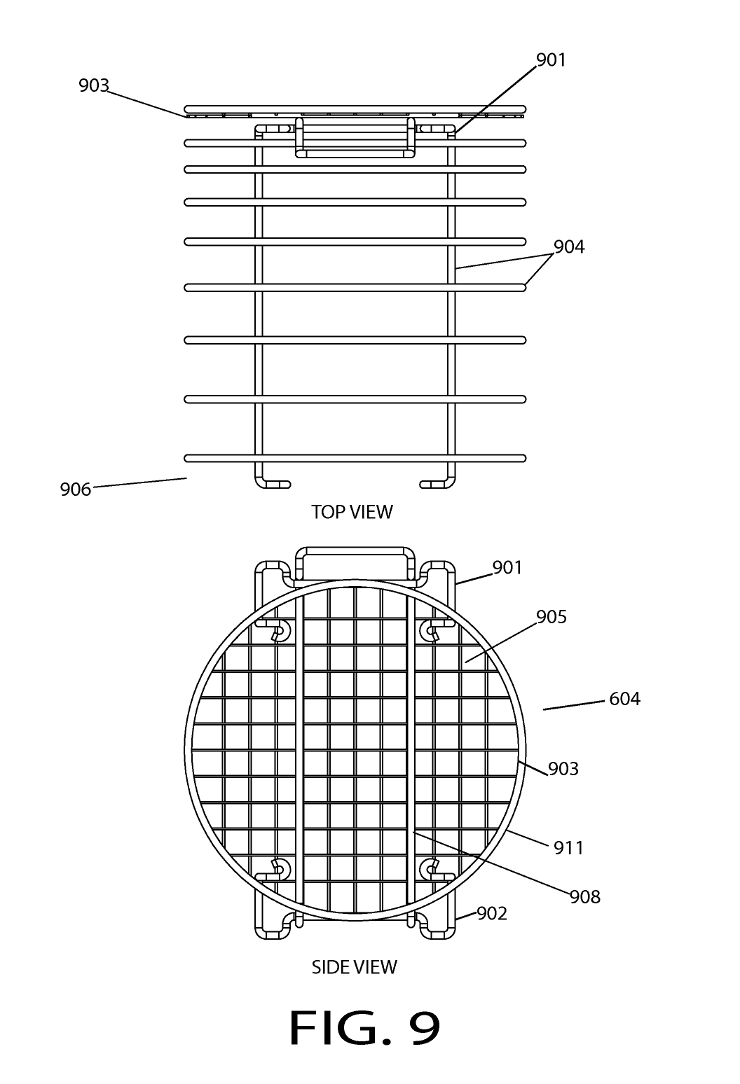

The infrared heat source assembly 204 comprises a plurality of near infrared bulbs arranged on a housing containing wiring that generally wires the plurality of near infrared bulbs together. In one embodiment, the housing is substantially box shaped wooden enclosure 600, wherein the box shaped enclosure has bulbs directed out of the bottom of the box. Although this is described as the bulbs coming out the bottom of the box shaped enclosure, when the enclosure is in use, the box shaped enclosure is turned on its side so that the bulbs are directed laterally. The bulbs are covered with a protective guard 604 (shown dotted in FIG. 6 because the bulbs and guard on are the opposite side of the box shaped enclosure 600 viewed in FIG. 6) shown in detail in FIG. 9 to prevent direct contact between the user and the bulbs. The infrared heat source assembly is comprised substantially of materials that emit little or no volatile organic compounds, wherein the panel is made of unadulterated wood and the protective guard is made of steel. However, the infrared heat source assembly 204 does contain the necessary plastics used only as electrical wiring insulation, so it is not entirely free of plastic.

The protective guard is generally in the shape of a cylinder having a cylinder section (see top view of FIG. 9), a first end and a second end and protects individual bulbs and the first end 906 of the cylinder is mounted onto the bottom of a box-shaped enclosure which will make up the heat source assembly. The protective guard shown in FIG. 9 is made of metal gratings or grills (openings are around one-half inch and not less than one quarter inch). The first end 906 is intended to be permanently mounted to the panel, but the cover 903 is capable of being opened by hand. The cover 903 can pivot on a hinge 902 and a latch 901 can be opened to access and replace the infrared bulbs. The cover 903 can be opened to remove and replace a bulb and then locked in place without the use of any tools. The cover 903 comprises the second end of the cylinder. A user sitting in the enclosure would see the side view, and a view from above the enclosure would be the top view shown in FIG. 9.

The protective guard 604 is a grilled safety apparatus. The grill is achieved by using an array of rigid wires that are rigid to protect the bulbs and the user from direct contact with the bulbs. It is rigid enough to guard against accidentally falling into the bulb or heat source assembly. The ideal size will prevent most fingers from inadvertently contacting the bulbs, particularly near the cover 903. At the same time, the array of rigid wires leave enough space so that sufficient infrared light is able to pass from the heat source assembly to the user. The array of rigid wires are welded together at the intersection of each two rigid wires for greater strength and stability. The protective guard 604 is created with robotic technology. The rigid wire array is plastic free and paint free, and is ideally electroplated steel.

In a preferred embodiment, the cover is comprised of an array of rigid wires 905 that are thinner and spaced more tightly than the array of wires 904 on the cylinder section. In this embodiment, the array of rigid wires 905 on the cover 903 are approximately one sixteenth of an inch in diameter and spaced approximately one half inch apart on center. The array of rigid wires 904 comprising the cylinder section are more rigid, and are at least one eighth inch in diameter, but less than one half inch. The array of rigid wires 904 comprising the cylinder section are not required to be spaced as tightly as the array of rigid wires 905 on the cover because the array of rigid wires 905 on the cover need to be spaced to prevent fingers from being inserted inside the protective guard which could expose fingers to the bulb which is capable of burning skin with direct contact. The wires 904 on the cylinder guard against larger objects or appendages or shoulders from grazing the sides of the bulb. In a preferred embodiment, the wires 904 on the cylinder are closer together towards the cover 903 than towards the first end 906. The array of rigid wires 905 on the cover are smaller in diameter than the array of rigid wires 904 on the cylinder section because the wires 905 on the cover must allow more near infrared light to pass to the user.

In a preferred embodiment, the hinge 902 and latch 901 are comprised as the same steel wire as the array of rigid wires 904 comprising the cylinder section. Additionally, the cover 903 is reinforced by rigid wire greater than one sixteenth inch in diameter but less than one quarter inch in diameter along the center 908 and the ring 911 around the cover 903.

Referring to FIG. 6, the assembly 600 is attached to the two vertical support bars such as 222 and 232 that extend from the side of the footprint with the smaller parallel side of the trapezoid. The assembly attaches to the vertical support rods at a plurality of mounting brackets 601. Ideally, each support rod would have two clamps, although one or more are sufficient. Ideally, each clamp will only need to be tightened at one point for each clamp.

In a preferred embodiment, the bulb mounting brackets 601 consists of a mounting clamp comprising a bracket 800 with bolt holes 806 and 808 that make the bracket 800 mountable to surfaces with screws or bolts and a clamping apparatus. In a preferred embodiment, the bracket 800 is permanently mounted to the assembly 600 using bolts. For a clamping apparatus, the bracket 800 has a raised surface 814 that can be laced with a strap 812. The strap 812 is laced below the raised surface 814 by lacing it through two openings 802 and 804. In the preferred embodiment, the strap is metal and contains grooves threaded to a thumbscrew 810 and will encircle a support rod. By tightening or loosening the thumbscrew 810, the strap 812 will either tighten or loosen around a support rod to fit tightly and hold the bulb assembly in place. In a preferred embodiment, the poles are the vertical support rods 222 and 232 shown in FIG. 2. The bulb assembly or infrared heat source can be lowered or raised by loosening the clamp and lifting the assembly to the desired level before tightening the clamp to lock the assembly in place.

In another embodiments, the bulb mounting brackets 601 may consist of thumbscrew inserted into one hole of a strap of one-half inch wide metal between ten and eighteen millimeters long with a hole punched into each strap end. Then the thumbscrew inserts into an L spring. The strap is bent into a circular shape and the thumbscrew inserts in the hole, creating a circular clamp. A speednut or Palnut is then threaded onto thumbscrew to keep all the clamp components together as one unit. The spring keeps the clamp wide as possible to receive the frame poles during installation and when the thumbscrew is loosened. This tension pushing the clamp wider keeps the strap from catching on a particular thread of the thumbscrew as the clamp is threaded and unthreaded. If the strap were to catch a thread, the strap would not widen as desired when the clamp was unthreaded and the thumbscrew could be unthreaded from the locknut and the clamp would become separated.

The infrared energy source provides comfort and therapeutic benefits. Due to the simplicity of the connections and the lightweight and associated portability of the framework and cover, the entire infrared sauna can be transported to locations of choice, such as the home. The cover will effectively seal heat and guards enclosing the infrared bulbs protect users from direct contact with hot bulbs.

Although this specification generally refers to the footprint of the enclosure as trapezoidal, it is intended to be within the scope and claims of this disclosure to cover shapes that are not trapezoids, but also to cover enclosures that deviate from the trapezoidal footprint. Other embodiments of the invention include enclosures having support rods on a small sidewall to support the infrared assembly and use a slightly larger sidewall on another side to fulfill the function of allowing for an entryway. The relatively smaller sidewall used to support the infrared assembly prevents wasted space near the infrared bulb space because this is an area that is often unusable because a user should not be within ten inches of the infrared bulb space. The lack of wasted space in this design makes the entire enclosure lighter and portable. The substantially isosceles trapezoid allows for easier assembly.

Referring to FIGS. 7A and 7B, where 7A shows a view looking towards the entrance to the enclosure and 7B shows the side view of an installed cover. The cover 701 is responsible for enclosing the sauna and trapping heat. The cover 701 has side loops 702 that provides for a double flap entry way 704. A side of each flap is pulled around the bottom corners 703 with side loops 702 that catch door straps to hold the door flaps open. A top view of the cover can be seen in FIG. 7C.

The cover 701 is made of a fabric such as cotton or canvas. The fabric comprising the cover 701 must be flexible so that it can be transported and reassembled easily, and it should also minimize the emission of volatile organic compounds. In a preferred embodiment, the fabric is 11.5 ounce cotton.

In another embodiment, a hinged door is used for accessing the enclosure. The door edge is attached to vertical support rod 201 (could also be reversed to attached at 211) with simple fabric or metal strap hinges. One hinge style is a long single fabric-based hinge running most of the height of the door. Another hinge style utilizes the mounting bracket (800) and thumbscrew clamp design, in which the clamp strap threads through slots on the door and clamps it to the frame's vertical pole. It has a wood knob handle 710 on both sides of the door for opening/closing. The door may be made of fabric or fabric with a rigid insert, or also made of more rigid material such as bamboo. Sleeves 711 receiving dowels are sewn into the edges of the door and may include one or more sleeves are sewn across the diagonal of the door to provide rigidity in all physical planes of the door. When dowels are seated in sleeves, the door becomes rigid enough to function as a door that doesn't flop/flex open.

I claim:

1. An infrared lamp guard comprising
a. A cylinder having a first end and a second end,
i. wherein the cylinder surrounds a single infrared light bulb, and
ii. wherein the first end is coupled to a panel, and
b. A circular cover coupled to the second end of the cylinder.

2. The infrared lamp guard of claim 1, wherein the cover is coupled to the cylinder via a hinge and the cover is capable of being latched to the cylinder opposite from the hinge.

3. The infrared lamp guard of claim 2, wherein the cover and the cylinder are comprised of an array of rigid wire.

4. The infrared lamp guard of claim 3, wherein the array of rigid wire comprising the cover is a finer mesh with tighter spacing than the array comprising the cylinder.

5. The infrared lamp guard of claim 1, wherein the panel is a heat source assembly having a plurality of light bulbs and corresponding infrared lamp guards and wherein the heat source assembly is coupled to a portable enclosure for use as an infrared sauna.

6. A sauna system comprising
an enclosure comprising a frame and cover, the frame having a footprint and being comprised of support rods held together by coupling pieces and
an infrared heat source assembly supported on the frame.

7. The sauna system of claim 6, wherein the coupling pieces consist of sockets.

8. The sauna system of claim 6, wherein the footprint of the frame is trapezoidal having a short section that is parallel to a long section and the infrared heat source assembly is attached to the support rods extending from the short section.

9. The sauna system of claim 6, wherein the frame and the cover and the coupling pieces are unadulterated materials.

10. The sauna system of claim 7, wherein the sockets are comprised of fabric with semi-rigid inserts.

11. The sauna system of claim 6, wherein the infrared heat source consists of a plurality of near infrared bulbs covered by protective guards and arranged in a housing that generates infrared light.

12. The sauna system of claim 11, wherein the infrared heat source is supported on the frame via mounting brackets comprising a screw threaded to a metal strap coupled to a bracket.

13. The sauna system of claim 11, wherein the bracket contains a raised surface and the metal strap is laced below the raised surface.

14. The sauna system of claim 12, wherein the screw is a thumbscrew.

15. A method of using a portable sauna system comprising the steps of
moving the system in a compacted form to a location
fitting support rods into coupling pieces to create a frame
attaching an infrared heat source assembly to the frame and
enclosing the frame with a fabric cover.

16. The method of claim 12, further comprising the step of activating the infrared heat source assembly to direct infrared radiation into the enclosure.

17. The method of claim 12, wherein the fitting of support rods into coupling pieces is performed with a push-pull assembly.

18. The method of claim 12, wherein the heat source assembly is capable of being attached to the frame with a mounting clamp without the use of tools.

19. The method of claim 12, wherein the fabric cover has a door that can be held open with side loops.

20. The method of claim 18, wherein the mounting clamp is tightened using a thumbscrew.
